(19) United States
(12) Patent Application Publication
(10) Pub. No.: US 2024/0336465 A1
(43) Pub. Date: Oct. 10, 2024

(54) X-SHAPED CROSS TUBE

(71) Applicant: CNH Industrial America LLC, New Holland, PA (US)

(72) Inventor: Dana Lee Froemming, Fargo, ND (US)

(21) Appl. No.: 18/132,503

(22) Filed: Apr. 10, 2023

(51) Int. Cl. B66F 9/20; E02F 3/43

(52) U.S. Cl. CPC B66F 9/205; E02F 3/431; B66F 9/12

(57) ABSTRACT

A work vehicle includes an attachment. The work vehicle also includes a lift assembly coupled to the attachment, wherein the lift assembly is configured to lower and to raise the attachment. The lift assembly includes a pair of lift arms. The lift assembly also includes an X-shaped cross tube coupled to and extending between the pair of lift arms. The X-shaped cross tube includes apertures configured to provide visibility between the pair of lift arms of a bottom edge of the attachment to an operator within the work vehicle when the attachment is at a full lift height.

### BACKGROUND

The present disclosure relates generally to work vehicles and, more particularly, to an X-shaped cross tube for utilization with a work vehicle (e.g., loader).

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A loader (e.g., wheel loader, skid-steer loader, excavator loader, etc.) is commonly used to load and move substantial volumes of material (e.g., dirt and similar material) from one location to another. A loader includes a relatively large frame and an implement or an attachment (e.g., bucket) mounted to one end of the frame. The implement may be selectively elevated and selectively tilted to dump materials therefrom. On certain machines, an operator's visibility of the attachment cutting edge is poor to non-existent when the attachment is lifted to full height and fully dumped.

### BRIEF DESCRIPTION

This brief description is provided to introduce a selection of concepts that are further described below in the detailed description. This summary is not intended to identify key or essential features of the claimed subject matter, nor is it intended to be used as an aid in limiting the scope of the claimed subject matter.

In one embodiment, a work vehicle is provided. The work vehicle includes an attachment. The work vehicle also includes a lift assembly coupled to the attachment, wherein the lift assembly is configured to lower and to raise the attachment. The lift assembly includes a pair of lift arms. The lift assembly also includes an X-shaped cross tube coupled to and extending between the pair of lift arms. The X-shaped cross tube includes apertures configured to provide visibility between the pair of lift arms of a bottom edge of the attachment to an operator within the work vehicle when the attachment is at a full lift height.

In another embodiment, a lift assembly for a work vehicle is provided. The lift assembly includes a pair of lift arms. The lift assembly also includes an X-shaped cross tube coupled to and extending between the pair of lift arms. The X-shaped cross tube includes apertures configured to provide visibility between the pair of lift arms of a bottom edge of an attachment coupled to the lift assembly to an operator within the work vehicle when the attachment is at a full lift height.

In a further embodiment, a cross tube for a lift assembly of a loader is provided. The cross tube includes a body having an X-shape. The body is configured to couple to and to extend between a pair of lift arms of the lift assembly that is pivotably coupled to a bucket. The body, when coupled to the pair of lift arms, includes apertures that are configured to provide visibility between the pair of lift arms of a cutting edge of a bucket to an operator within the loader when the bucket is at a full lift height and in a fully dumped position.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 illustrates a side view of a work vehicle (e.g., wheel loader) equipped with an implement or attachment (e.g., bucket), in accordance with aspects of the disclosure;

FIG. 2 illustrates a perspective view of a portion of a lift assembly having an X-shaped cross tube, in accordance with aspects of the present disclosure;

FIG. 3 illustrates another perspective view of the portion of the lift assembly in FIG. 2, in accordance with aspects of the present disclosure

FIG. 4 illustrates a schematic view of an operator's view of the lift assembly coupled to the attachment (e.g., at max lift in a first tilting position), in accordance with aspects of the present disclosure;

FIG. 5 illustrates a schematic view of an operator's view of the lift assembly coupled to the attachment (e.g., at max lift in a second tilting position), in accordance with aspects of the present disclosure;

FIG. 6 illustrates a schematic view of an operator's view of the lift assembly coupled to the attachment (e.g., at max lift in a third tilting position), in accordance with aspects of the present disclosure;

FIG. 7 illustrates a schematic view of an operator's view of the lift assembly coupled to the attachment (e.g., at max lift in a fourth tilting position), in accordance with aspects of the present disclosure;

FIG. 8 illustrates a schematic view of an operator's view of the lift assembly coupled to the attachment (e.g., at max lift in a fifth tilting position (i.e., a fully dumped position), in accordance with aspects of the present disclosure;

FIG. 9 illustrates a schematic view of an operator's visibility as a lift assembly is at max lift and in a fully dumped position dumping a load into a work vehicle, in accordance with aspects of the present disclosure;

FIG. 10 illustrates a schematic view of an operator's view of the lift assembly coupled to the attachment (e.g., forklift) with the attachment on the ground, in accordance with aspects of the present disclosure; and

FIG. 11 illustrates a schematic view of an operator's view of the lift assembly coupled to the attachment (e.g., forklift) with the attachment lifted, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Embodiments of the present disclosure relate generally to utilizing an X shaped cross tube to increase visibility of an operator of an attachment (e.g., bucket or forklift) coupled to a lift assembly of a work vehicle (e.g., wheel loader, skid-steer loader, excavator loader, etc.). In particular, a lift assembly includes a pair of lift or loaders arms coupled to an attachment, wherein the lift assembly is configured to lower and to raise the attachment. The lift assembly includes an X-shaped cross tube coupled to and extending between the pair of lift arms. The X-shaped cross tube includes apertures or windows configured to provide visibility between the pair of lift arms of a bottom edge of the attachment to an operator within the work vehicle when the attachment is at a full lift height. In certain embodiments, when the attachment is a bucket, the apertures or windows are configured to provide visibility between the pair of lift arms of a cutting edge of the attachment to an operator within the work vehicle when the attachment is at a full lift height and in a fully dumped position (fully tilted position to dump load). The X-shaped cross tube includes a body having the X-shape. The apertures include a first aperture disposed on a first side of the X-shaped cross tube, a second aperture disposed on a second side of the X-shaped cross tube opposite the first side, the first side being closer to the attachment, a third aperture disposed on a third side of the X-shaped cross tube between a first lift arm of the pair of lift arms and the X-shaped cross tube, and a fourth aperture disposed on a fourth side of the X-shaped cross tube opposite the third side between a second lift arm of the pair of lift arms and the X-shaped cross tube. In certain embodiments, edges of at least one of the first side, the second side, the third side, and the fourth side of the X-shaped cross tube are rounded (e.g., bullnosed) to increase operator visibility. In certain embodiments, respective edges of each of the first side, the second side, the third side, and fourth side of the X-shaped cross tube are rounded (e.g., bullnosed) to increase operator visibility. The lift assembly comprises a single plate bellcrank mount (as opposed to a pair of plates for the bellcrank mount) coupled to the X-shaped cross tube to reduce masking by the bellcrank mount of visibility (e.g., relative to the bellcrank mount having the pair of plates). The apertures are configured to provide visibility between the pair of lift arms of the bottom edge of the attachment to the operator within the work vehicle to both a left side and a right side of the single plate bellcrank mount when the attachment is at the full lift height. In certain embodiments, the X-shaped cross tube may be manufactured via casting. In certain embodiments, the X-shaped cross tube may be fabricated from tubes or flat plates.

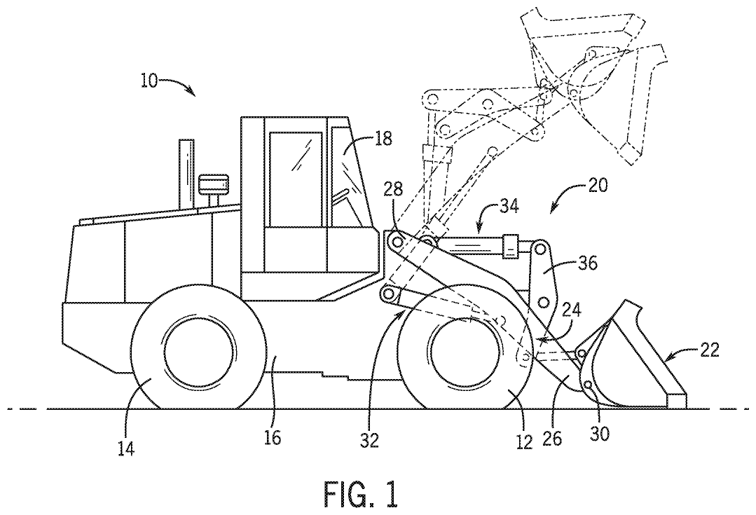

FIG. 1 illustrates a side view of a work vehicle 10 (e.g., wheel loader) equipped with an implement or attachment 22 (e.g., bucket). In certain embodiments, the work vehicle may be a skid-steer loader, an excavator loader, or any other type of loader having the implement 22 for handling a load. As shown, the work vehicle 10 includes a pair of front tires 12, (one of which is shown), a pair of rear tires 14 (one of which is shown) and a frame or chassis 16 coupled to and supported by the tires 12, 14. An operator's cab 18 may be supported by a portion of the chassis 16 and may house various input devices for permitting an operator to control the operation of the work vehicle 10.

Moreover, as shown in FIG. 1, the work vehicle 10 may include a lift assembly 20 (e.g., actuation system) for raising and lowering a suitable implement 22 (e.g., a bucket) relative to a driving surface of the vehicle 10. In several embodiments, the lift assembly 20 may include a pair of loader arms or lift arms 24 (one of which is shown) pivotally coupled between the chassis 16 and the implement 22. For example, as shown in FIG. 1, each loader arm 24 (e.g., boom) may include a forward end 26 and an aft end 28, with the forward end 26 being pivotally coupled to the implement 22 at a forward pivot point 30 and the aft end 28 being pivotally coupled to a portion of the chassis 16.

In addition, the lift assembly 20 may also include a pair of hydraulic lift cylinders 32 (one of which is shown) coupled between the chassis 16 and the loader arms 24 and a hydraulic tilt cylinder 34 coupled between the chassis 16 and the implement 22 (e.g., via a pivotally mounted bellcrank plate 36 or other mechanical linkage). It should be readily understood by those of ordinary skill in the art that the lift and tilt cylinders 32, 34 may be utilized to allow the implement 22 to be raised/lowered and/or pivoted relative to the driving surface of the work vehicle 10. For example, the lift cylinders 32 may be extended and retracted in order to pivot the loader arms 24 upward and downwards, respectively, thereby at least partially controlling the vertical positioning of the implement 22 relative to the driving surface. Similarly, the tilt cylinder 34 (e.g., bucket cylinder) may be extended and retracted in order to pivot the implement 22 relative to the loader arms 24 about the forward pivot point 30, thereby controlling the tilt angle or orientation of the implement 22 relative to the driving surface or ground. The number of linkages and/or cylinders of the lift assembly 20 may vary. As depicted, the lift assembly 20 includes a Z-linkage. In certain embodiments, the lift assembly 20 includes a parallel lift linkage.

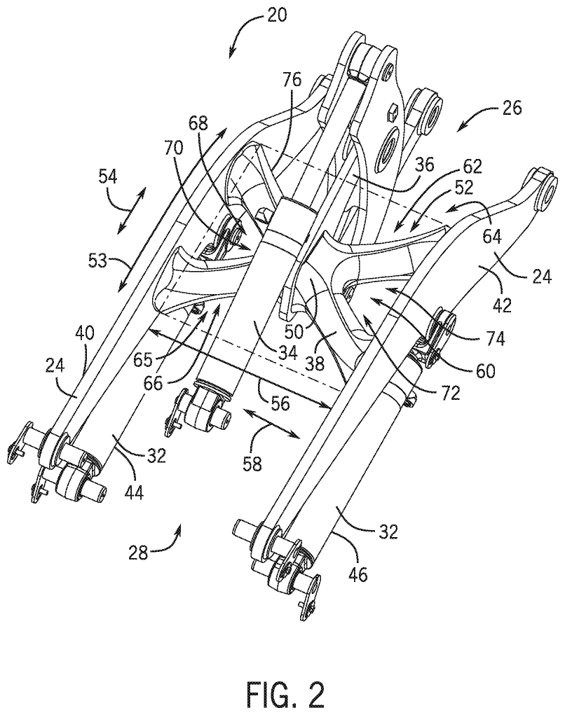

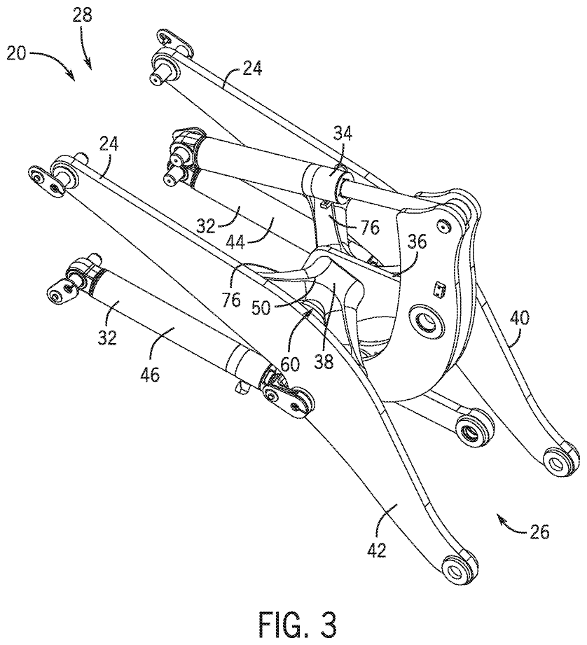

FIGS. 2 and 3 illustrate different perspective views (e.g., from above) of a portion of the lift assembly 20 having an X-shaped cross tube 38. In certain embodiments, the X-shaped cross tube 38 may be manufactured via casting. In certain embodiments, the X-shaped cross tube 38 may be fabricated from tubes or flat plates. The lift assembly includes 20 includes the pair of loader arms or lift arms 24 (e.g., lift arms 40 and 42) laterally spaced apart from each other. The X-shaped cross tube 38 is coupled to and extends between the pair of lift arms 24. The lift assembly 20 includes the pair of lift arms 24 coupled to the pair of lift cylinders 32 (e.g., lift cylinders 44 and 46). In particular, the lift cylinder 44 is coupled to the lift arm 40 and the lift cylinder 46 is coupled to the lift arm 42. The lift assembly 20 also includes the pivotally mounted bellcrank plate 36 (i.e., a single plate) coupled to (e.g., mounted on) the X-shaped cross tube 38. The pivotally mounted bellcrank plate 36 is indirectly coupled to the hydraulic tilt cylinder 34 via a pair of plates 48 that flank the bellcrank plate 36.

The X-shaped cross tube 38 includes a body 50 having an X-shape. The X-shaped cross tube 38 extends across an area 52 defined by a first length 53 of the X-shaped cross tube 38 extending in a direction 54 between the forward end 26 and the aft end 28 of the pair of lift arms 24 and a second length 56 extending in a direction 58 (e.g., orthogonal to the direction 54) between the pair of lift arms 24.

The X-shaped cross tube 38 includes a plurality of windows or apertures 60 disposed within the area 52 configured to provide visibility between the pair of lift arms 24 of a bottom edge of the attachment (e.g., coupled to the forward end 26 of the pair of lift arms 24) to an operator within the work vehicle (when seated in a standard upright position facing the lift assembly 20) when the attachment is at a full lift height. The plurality of apertures 60 include a first aperture 62 disposed on a first side 64 of the X-shaped cross tube 38, a second aperture 65 disposed on a second side 66 of the X-shaped cross tube 38 opposite the first side 64, the first side 64 being closer to the attachment than the second side 66, a third aperture 68 disposed on a third side 70 of the X-shaped cross tube 38 between the lift arm 40 of the pair of lift arms 24 and the X-shaped cross tube 38, and a fourth aperture 72 disposed on a fourth side 74 of the X-shaped cross tube 38 opposite the third side 70 between a second lift arm 42 of the pair of lift arms 24 and the X-shaped cross tube 38. Each aperture 60 has a triangular-shaped area within the area 52. Respective areas of the apertures 68 and 70 are greater than the respective areas of the apertures 62 and 65.

Each side 64, 66, 70, and 74 of the body 50 of the X-shaped cross tube 38 includes a pair of edges 76. In certain embodiments, at least one pair of edges 76 of one of sides 64, 66, 70, and 74 are rounded (e.g., bullnosed) to increase operator visibility. In certain embodiments (as depicted in FIGS. 2 and 3), respective pair of edges 76 of each of the sides 64, 66, 70, and 74 of the X-shaped cross tube 38 are rounded (e.g., bullnosed) to increase operator visibility. The visibility provided by the plurality of apertures 60 is greater than a cross tube lacking any apertures extending across the same area 52.

In certain embodiments, when the attachment is a bucket, the plurality of windows or apertures 60 disposed within the area 52 are configured to provide visibility (e.g., complete visibility) between the pair of lift arms 24 of a cutting edge of the attachment (e.g., pivotably coupled to the forward end 26 of the pair of lift arms 24) to an operator within the work vehicle (when seated in a standard upright position facing the lift assembly 20) when the attachment is at a full lift height and in a fully dumped position (fully tilted position to dump load). In certain embodiments, when the attachment is a forklift, the plurality of windows or apertures 60 disposed within the area 52 are configured to provide visibility between the pair of lift arms 24 of a bottom edge of the forklift (e.g., coupled to the forward end 26 of the pair of lift arms 24) to an operator within the work vehicle (when seated in a standard upright position facing the lift assembly 20) when the attachment is at a full lift height. In certain embodiments, when the attachment is a forklift, the plurality of windows or apertures 60 disposed within the area 52 are configured to provide visibility between the pair of lift arms 24 of the ends of the forks of the forklift (e.g., coupled to the forward end 26 of the pair of lift arms 24) to an operator within the work vehicle (when seated in a standard upright position facing the lift assembly 20) when the attachment is in a fully lowered position.

Utilization of the single plate bellcrank mount 36 coupled to the X-shaped cross tube 38 also increases operator visibility. The single plate bellcrank mount 36 (as opposed to a pair of plates for the bellcrank mount) reduce masking by the bellcrank mount 36 of visibility (e.g., relative to the bellcrank mount having the pair of plates). The plurality of apertures 60 are configured to provide visibility between the pair of lift arms 24 of the bottom edge of the attachment to the operator within the work vehicle to both a left side 78 and a right side 80 of the single plate bellcrank mount 36 when the attachment is at the full lift height.

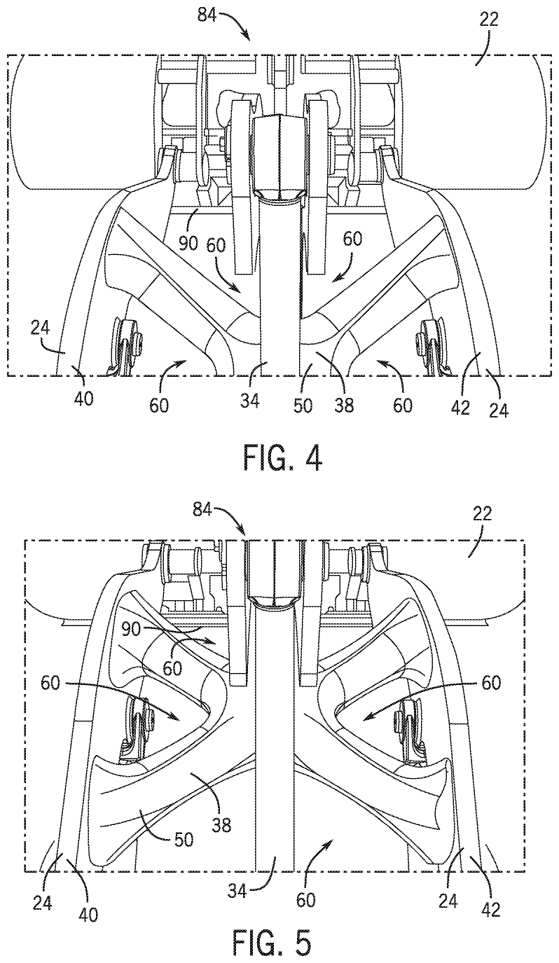

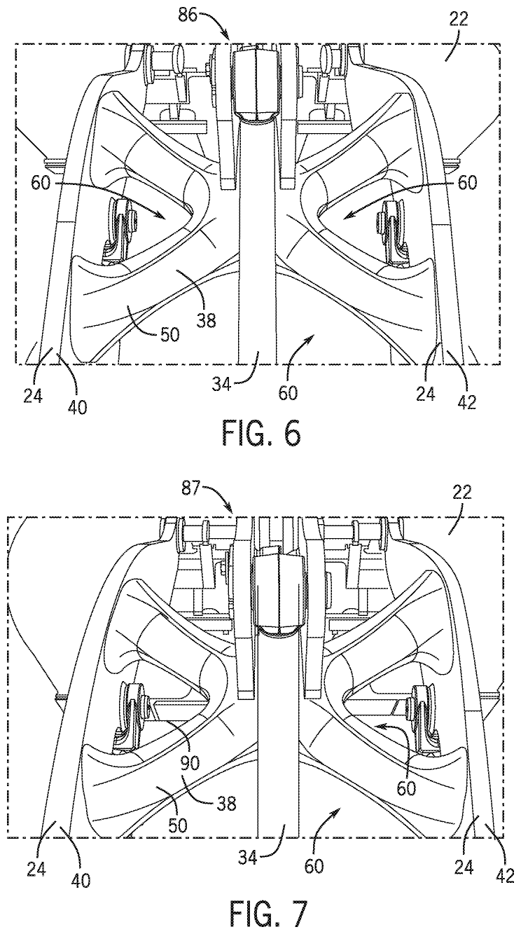

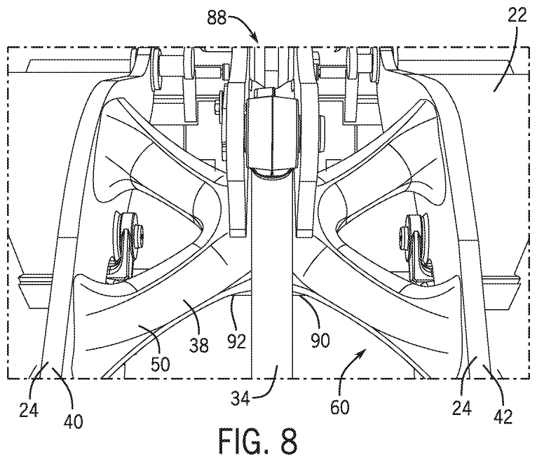

FIGS. 4-8 illustrate schematic views of an operator's view of the lift assembly 20 coupled to the attachment 22 (e.g., bucket) at a max lift position (i.e., full lift height) at a variety of tilting positions (e.g., relative to the pivot point 30 in FIG. 1). FIGS. 4-8 illustrate tilting positions 82, 84, 86, 87, and 88. Tilting position 82 has the least amount of tilt (e.g., about the pivot point) of the attachment 22 toward the ground of the tilting positions 82, 84, 86, 87, and 88. Tilting position 84 has a little more tilt (e.g., about the pivot) of the attachment 22 toward the ground than the tilting position 82. Tilting position 86 has a little more tilt (e.g. about the pivot) of the attachment 22 toward the ground than both the tilting positions 82 and 84. Tilting position 87 has a little more tilt (e.g. about the pivot) of the attachment 22 toward the ground than both the tilting positions 82, 84, and 86. Tilting position 88 has the most amount of tilt (e.g., about the pivot) of the attachment 22 toward the ground of the tilting positions 82, 84, 86, 87, and 88. The tilting position 88 is the fully dumped position for emptying the load from the attachment 22. As depicted in FIGS. 4-8, the operator (when seated in a standard upright position facing the lift assembly 20 within the cab) can view a bottom edge 90 of the attachment 22 through the pairs of lift arms 24 via the apertures 60 defined by the X-shaped cross tube 38 (in conjunction with the reduced visibility masking by the single plate bellcrank mount 36). As depicted in FIG. 8, the operator (when seated in a standard upright position facing the lift assembly 20 within the cab) can view a cutting edge 92 of the attachment 22 when at the full lift height and in the fully dumped position through the pairs of lift arms 24 via the apertures 60 defined by the X-shaped cross tube 38 (in conjunction with the reduced visibility masking by the single plate bellcrank mount 36).

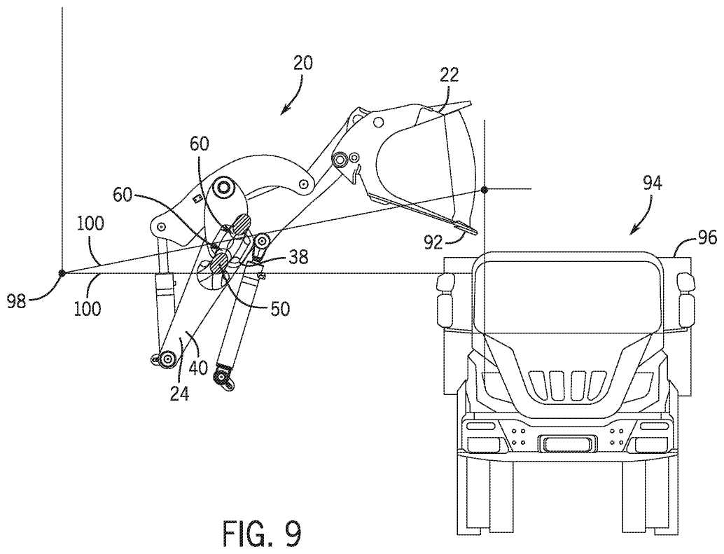

FIG. 9 illustrates a schematic view of an operator's visibility as the lift assembly 20 is at max lift (i.e., full lift height) and in a fully dumped position (e.g., as seen in FIG. 8) dumping a load into a work vehicle 94 (e.g., a bed 96 of the work vehicle 94 (e.g., dump truck). A cross section of the lift assembly 20 along its longitudinal length is shown. Not all components (e.g., cylinders) are shown of the lift assembly 20. Point 98 represents the spot where an operator's vision originates when seated in a standard upright position facing the lift assembly 20 within the cab of a work vehicle (e.g., loader). Lines 100 outline the line of vision of the operator from the point 98. As depicted in FIG. 9, the operator has a line of sight of the cutting edge 92 of the attachment 22 through the apertures 60 of the X-shaped cross tube 38 when the lift assembly 20 is at max lift and in a fully dumped position. In this case, it enables the operator to see the cutting edge 92 of the attachment 22 relative to a top edge 102 of the bed of the work vehicle 94.

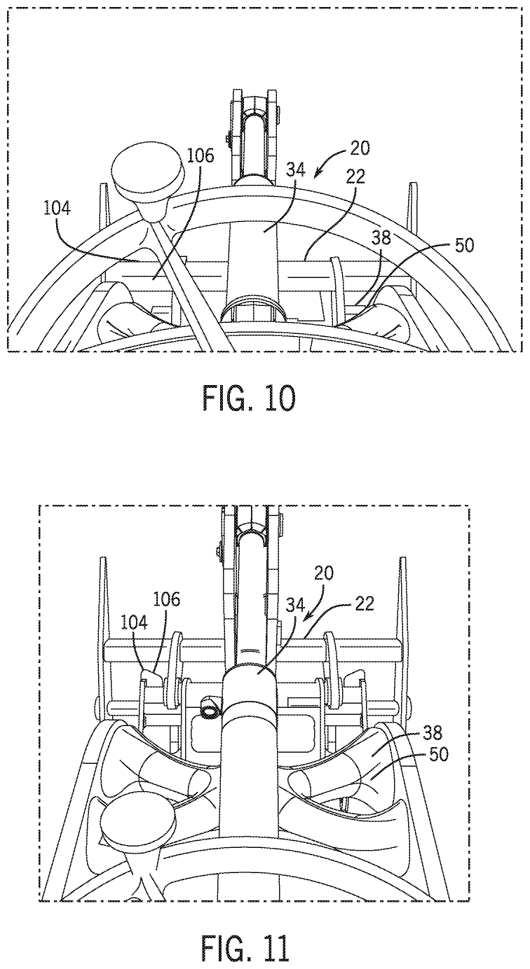

FIG. 10 illustrates a schematic view of an operator's view of the lift assembly 20 coupled to the attachment 22 (e.g., forklift) with the attachment 22 on the ground. FIG. 11 illustrates a schematic view of an operator's view of the lift assembly 20 coupled to the attachment 22 (e.g., forklift) with the attachment 22 lifted (e.g., approximately 4 feet above the ground. The X-shaped cross tube 38 is as described above in FIGS. 2 and 3. As depicted in both FIGS. 10 and 11, the operator (when seated in a standard upright position facing the lift assembly 20 within the cab) can see an end 104 of forks 106 of the attachment 22.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A work vehicle, comprising:
an attachment;
a lift assembly coupled to the attachment, wherein the lift assembly is configured to lower and to raise the attachment, and wherein the lift assembly comprises:
a pair of lift arms; and
an X-shaped cross tube coupled to and extending between the pair of lift arms, wherein the X-shaped cross tube comprises apertures configured to provide visibility between the pair of lift arms of a bottom edge of the attachment to an operator within the work vehicle when the attachment is at a full lift height.

2. The work vehicle of claim 1, wherein the apertures comprise a first aperture disposed on a first side of the X-shaped cross tube, a second aperture disposed on a second side of the X-shaped cross tube opposite the first side, the first side being closer to the attachment, a third aperture disposed on a third side of the X-shaped cross tube between a first lift arm of the pair of lift arms and the X-shaped cross tube, and a fourth aperture disposed on a fourth side of the X-shaped cross tube opposite the third side between a second lift arm of the pair of lift arms and the X-shaped cross tube.

3. The work vehicle of claim 2, wherein edges of at least one of the first side, the second side, the third side, and the fourth side of the X-shaped cross tube are rounded to increase operator visibility.

4. The work vehicle of claim 3, wherein respective edges of each of the first side, the second side, the third side, and the fourth side of the X-shaped cross tube are rounded to increase operator visibility.

5. The work vehicle of claim 1, wherein the lift assembly comprises a single plate bellcrank mount coupled to the X-shaped cross tube.

6. The work vehicle of claim 5, wherein the apertures are configured to provide visibility between the pair of lift arms of the bottom edge of the attachment to the operator within the work vehicle to both a left side and a right side of the single plate bellcrank mount when the attachment is at the full lift height.

7. The work vehicle of claim 1, wherein the attachment comprises a forklift.

8. The work vehicle of claim 1, wherein the attachment comprises a bucket.

9. The work vehicle of claim 8, wherein the lift assembly is pivotably coupled to the bucket, and wherein the apertures are configured to provide visibility between the pair of lift arms of a cutting edge of the bucket to the operator within the work vehicle when the bucket is at the full lift height and in a fully dumped position.

10. A lift assembly for a work vehicle, comprising:
a pair of lift arms; and
an X-shaped cross tube coupled to and extending between the pair of lift arms, wherein the X-shaped cross tube comprises apertures configured to provide visibility between the pair of lift arms of a bottom edge of an attachment coupled to the lift assembly to an operator within the work vehicle when the attachment is at a full lift height.

11. The lift assembly of claim 10, wherein the apertures comprise a first aperture disposed on a first side of the X-shaped cross tube, a second aperture disposed on a second side of the X-shaped cross tube opposite the first side, the first side being closer to the attachment, a third aperture disposed on a third side of the X-shaped cross tube between a first lift arm of the pair of lift arms and the X-shaped cross tube, and a fourth aperture disposed on a fourth side of the X-shaped cross tube opposite the third side between a second lift arm of the pair of lift arms and the X-shaped cross tube.

12. The lift assembly of claim 11, wherein edges of at least one of the first side, the second side, the third side, and the fourth side of the X-shaped cross tube are rounded to increase operator visibility.

13. The lift assembly of claim 12, wherein respective edges of each of the first side, the second side, the third side, and the fourth side of the X-shaped cross tube are rounded to increase operator visibility.

14. The lift assembly of claim 10, further comprising a single plate bellcrank mount coupled to the X-shaped cross tube.

15. The lift assembly of claim 14, wherein the apertures are configured to provide visibility between the pair of lift arms of the bottom edge of the attachment to the operator within the work vehicle to both a left side and a right side of the single plate bellcrank mount when the attachment is at the full lift height.

16. The lift assembly of claim 10, wherein the attachment comprises a forklift.

17. The lift assembly of claim 10, wherein the attachment comprises a bucket.

18. The lift assembly of claim 17, wherein the lift assembly is pivotably coupled to the bucket, and wherein the apertures are configured to provide visibility between the pair of lift arms of a cutting edge of the bucket to the operator within the work vehicle when the bucket is at the full lift height and in a fully dumped position.

19. A cross tube for a lift assembly of a loader, comprising:
a body having an X-shape, wherein the body is configured to couple to and to extend between a pair of lift arms of the lift assembly that is pivotably coupled to a bucket, and the body, when coupled to the pair of lift arms, comprises apertures that are configured to provide visibility between the pair of lift arms of a cutting edge of a bucket to an operator within the loader when the bucket is at a full lift height and in a fully dumped position.

20. The cross tube of claim 19, wherein the apertures comprise a first aperture disposed on a first side of the body, a second aperture disposed on a second side of the body opposite the first side, the first side being closer to the bucket, a third aperture disposed on a third side of the body between a first lift arm of the pair of lift arms and the body, and a fourth aperture disposed on a fourth side of the body opposite the third side between a second lift arm of the pair of lift arms and the body, and wherein respective edges of each of the first side, the second side, the third side, and the fourth side of the body are rounded to increase operator visibility.
